(19) United States
(12) Patent Application Publication
(10) Pub. No.: US 2019/0222340 A1
(43) Pub. Date: Jul. 18, 2019

(54) Enhanced Cell Search

(71) Applicant: Nokia Technologies Oy, Espoo (FI)

(72) Inventors: Jorma KAIKKONEN, Oulo (FI); Sami-Jukka Hakola, Kempele (FI)

(21) Appl. No.: 16/245,456

(22) Filed: Jan. 11, 2019

Related U.S. Application Data
(60) Provisional application No. 62/616,764, filed on Jan. 12, 2018.

(51) Int. Cl. H04J 11/00; H04B 1/7083; H04B 1/7073; H04B 1/7075; H04W 56/00

(52) U.S. Cl. CPC H04J 11/0086; H04B 1/7083; H04B 1/70735; H04W 56/00; H04B 1/70758; H04J 11/0079; H04B 1/70754

(57) ABSTRACT

A search is performed by a UE for cells in a wireless communication system, comprising: searching, in a frequency band, for a block that comprises a SS; determining, in response to finding the SS within the block, whether there is an indication in the block of a frequency range in which no remaining system information will be found; and continuing, in response to the indication being in the block, to search for cells in frequencies after the particular frequency. A network element determines that no remaining system information is to be transmitted in a block and in subsequent block(s) to be transmitted over a frequency band, and transmits the block with a SS used for UEs to search for cells, and with indication of a frequency range, from a current frequency corresponding to the transmitted block and in the frequency band, over which no remaining system information will be found.

### TECHNICAL FIELD

This invention relates generally to physical layer design for wireless communication systems, and, more specifically, relates to new radio (NR) physical layer design.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below, after the main part of the detailed description section.

For a cell search, a gNB transmits periodically a synchronization signal/physical broadcast channel (SS/PBCH) block burst set, where the set can consist of up to L SS/PBCH blocks transmitted in fixed time domain locations within a half radio frame. As is known, a radio frame is equal to 10 ms and a half radio frame is equal to 5 ms. The variable L depends on carrier frequency range:
L=4 for below 3 GHz;
L=8 for frequencies between 3 and 6 GHz; and
L=64 for above 6 GHz.

Fixed time domain locations of the SS/PBCH blocks (SSBs) within a half frame (HF) depend on applied subcarrier spacing for the SSBs of the cell. An SSB comprises a primary synchronization signal (PSS) and a secondary synchronization signal (SSS) for time and frequency synchronization acquisition and physical cell ID determination of the detected cell, and physical broadcast channel (PBCH) along with demodulation reference signal (DMRS) for acquisition of the timing information (e.g., slot, half frame and frame timing) as well as for acquisition of the most essential system information. This system information comprises configuration of the control resource set (CORESET) and monitoring pattern for PDCCH scheduling of the remaining system information (RMSI). As stated in more detail below, the PBCH provides a UE with information as to how the UE can receive PDCCH that is used to schedule PDSCH which carries actual (remaining) minimum system information as payload.

SSBs used for the cell search and initial access are located in a predefined synchronization raster defined in specifications for each frequency band. There can also be SSBs for other purposes which are not located in a synchronization raster.

PBCH in SSB, as said above, provides CORESET and monitoring pattern configuration for PDCCH detection that schedules the RMSI. In other words, SSB may be associated with the RMSI. It is also possible that SSB is not associated with the RMSI and then PBCH indicates where the UE can find the SSB which is associated with the RMSI. The association here means that the SSB and RMSI (PDCCH+PDSCH) are transmitted within a bandwidth not greater than the bandwidth the UEs will support.

### BRIEF SUMMARY

This section is intended to include examples and is not intended to be limiting.

An exemplary comprises performing a search for cells in a wireless communication system, comprising the following: searching, by a user equipment and in a frequency band, for a block that comprises a synchronization signal; determining, by the user equipment and in response to finding the synchronization signal within the block, whether there is an indication in the block of a frequency range in which no remaining system information will be found; and continuing, by the user equipment and in response to the indication being in the block, to search for cells in frequencies after the particular frequency.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus to perform at least the following: performing a search for cells in a wireless communication system, comprising: code for searching, by a user equipment and in a frequency band, for a block that comprises a synchronization signal; determining, by the user equipment and in response to finding the synchronization signal within the block, whether there is an indication in the block of a frequency range in which no remaining system information will be found; and continuing, by the user equipment and in response to the indication being in the block, to search for cells in frequencies after the particular frequency.

An exemplary computer program product includes a computer-readable storage medium bearing computer program code embodied therein for use with a computer. The computer program code includes: code for performing a search for cells in a wireless communication system, comprising: code for searching, by a user equipment and in a frequency band, for a block that comprises a synchronization signal; code for determining, by the user equipment and in response to finding the synchronization signal within the block, whether there is an indication in the block of a frequency range in which no remaining system information will be found; and code for continuing, by the user equipment and in response to the indication being in the block, to search for cells in frequencies after the particular frequency.

In another exemplary embodiment, an apparatus comprises: means for performing a search for cells in a wireless communication system, comprising: means for searching, by a user equipment and in a frequency band, for a block that comprises a synchronization signal; means for determining, by the user equipment and in response to finding the synchronization signal within the block, whether there is an indication in the block of a frequency range in which no remaining system information will be found; and means for continuing, by the user equipment and in response to the indication being in the block, to search for cells in frequencies after the particular frequency.

In an exemplary embodiment, a method is disclosed that includes determining, by a network element able to communicate with user equipment in a wireless communication system, that no remaining system information is to be transmitted in a block and in one or more subsequent blocks to be transmitted over a frequency band. The method includes transmitting the block, wherein the block comprises a synchronization signal and is used for user equipment to search for cells, and including in the block an indication of a frequency range, from a current frequency corresponding to the transmitted block and in the frequency band, over which no remaining system information will be found.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus to perform at least the following: determining, by a network element able to communicate with user equipment in a wireless communication system, that no remaining system information is to be transmitted in a block and in one or more subsequent blocks to be transmitted over a frequency band; and transmitting the block, wherein the block comprises a synchronization signal and is used for user equipment to search for cells, and including in the block an indication of a frequency range, from a current frequency corresponding to the transmitted block and in the frequency band, over which no remaining system information will be found.

An exemplary computer program product includes a computer-readable storage medium bearing computer program code embodied therein for use with a computer. The computer program code includes: code for determining, by a network element able to communicate with user equipment in a wireless communication system, that no remaining system information is to be transmitted in a block and in one or more subsequent blocks to be transmitted over a frequency band; and code for transmitting the block, wherein the block comprises a synchronization signal and is used for user equipment to search for cells, and including in the block an indication of a frequency range, from a current frequency corresponding to the transmitted block and in the frequency band, over which no remaining system information will be found.

In another exemplary embodiment, an apparatus comprises: means for determining, by a network element able to communicate with user equipment in a wireless communication system, that no remaining system information is to be transmitted in a block and in one or more subsequent blocks to be transmitted over a frequency band; and means for transmitting the block, wherein the block comprises a synchronization signal and is used for user equipment to search for cells, and including in the block an indication of a frequency range, from a current frequency corresponding to the transmitted block and in the frequency band, over which no remaining system information will be found.

A communication system is also disclosed comprising the apparatus previously described and described also in more detail below.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 is an illustration of a frequency band with SSBs and operations performed in accordance with an exemplary embodiment herein;

FIG. 3 is a logic flow diagram for enhanced cell search performed by a UE, and illustrates the operation of an exemplary method or methods, a result of execution of computer program instructions embodied on a computer readable memory, functions performed by logic implemented in hardware, and/or interconnected means for performing functions in accordance with exemplary embodiments;

FIG. 4 is a logic flow diagram for enhanced cell search performed by a network element such as a gNB, and illustrates the operation of an exemplary method or methods, a result of execution of computer program instructions embodied on a computer readable memory, functions performed by logic implemented in hardware, and/or interconnected means for performing functions in accordance with exemplary embodiments;

FIG. 5 is a table of SS raster entries and their corresponding frequency ranges;

FIG. 6 is a table indicating ranges for different SS raster step sizes;

FIG. 7 is a table illustrating channel raster for NR per frequency range;

FIG. 8 is a table illustrating initial CFOs and frequency difference between neighboring SS raster entries;

FIG. 9 is a table illustrating 7-bit signaling in NR-PBCH for SS-subcarrier-offset, SS raster entry within a cluster of entries, on- or off-SS raster SS/PBCH block and RMSI presence indication at below 6 GHz; and

FIG. 10 is a table illustrating 4-bit signaling for SS-subcarrier-offset, on- or off-SS raster SS/PBCH block and RMSI presence indication at above 6 GHz.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe techniques for enhanced cell search. Additional description of these techniques is presented after a system into which the exemplary embodiments may be used is described.

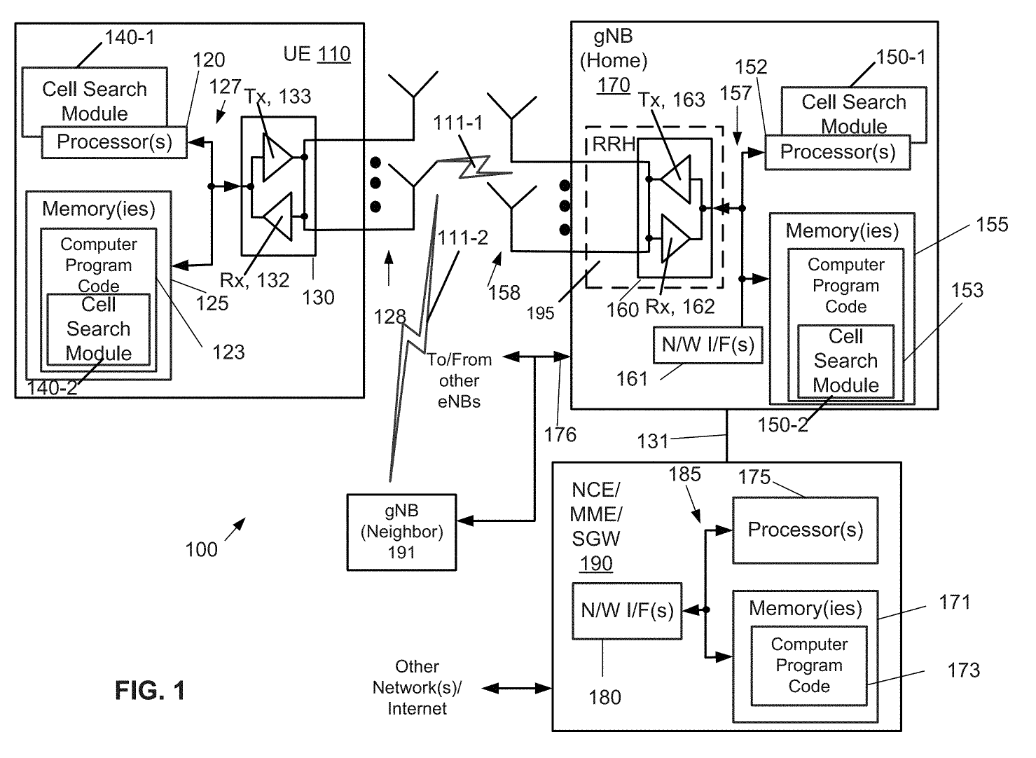

Turning to FIG. 1, this figure shows a block diagram of one possible and non-limiting exemplary system in which the exemplary embodiments may be practiced. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a cell search module 140, comprising one of or both parts 140-1 and/or 140-2, which may be implemented in a number of ways. The cell search module 140 may be implemented in hardware as cell search module 140-1, such as being implemented as part of the one or more processors 120. The cell search module 140-1 may be implemented also as an integrated circuit or through other hardware such as a programmable gate array. In another example, the cell search module 140 may be implemented as cell search module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein.

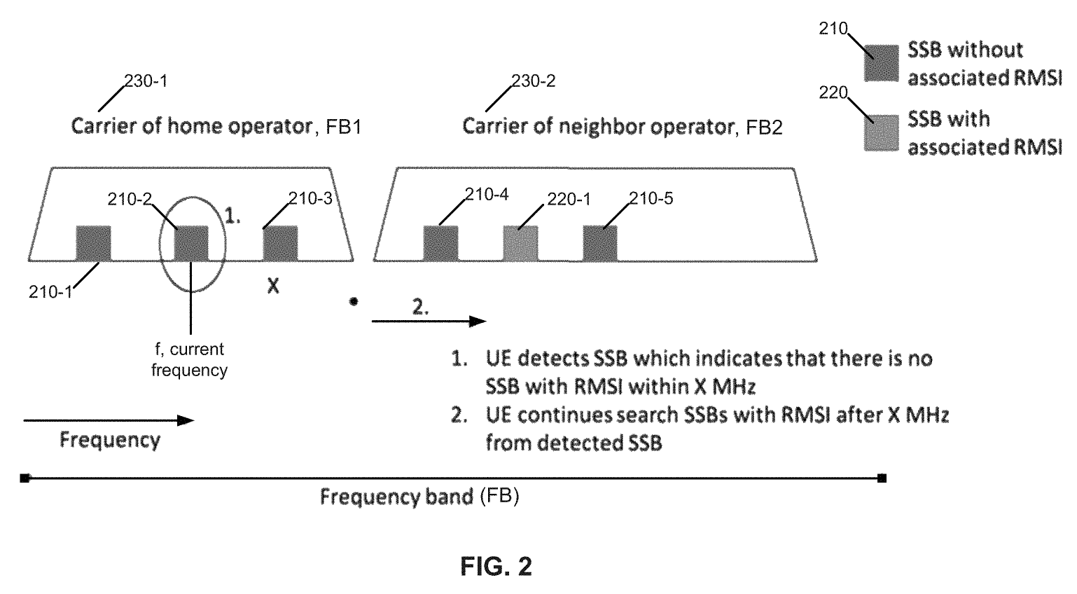

In this example, the UE 110 communicates with gNB 170 via a wireless link 111-1. It is primarily assumed that the gNB being described below is a single gNB 170. However, FIG. 2 described below uses a home operator, e.g., with gNB 170, and a neighbor operator, e.g., with gNB 191. The UE 110 may also communicate with the neighbor gNB 191, via link 111-2. It is possible that both gNBs 170 and 191 implement the exemplary embodiments, but this is not necessary. If both the gNBs 170 and 191 implement the exemplary embodiments herein, then the description of gNB 170 will also apply to gNB 191.

The gNB (evolved NodeB) 170 is a base station (e.g., for NR/5G) that provides access by wireless devices such as the UE 110 to the wireless network 100. The gNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The gNB 170 includes a cell search module 150, comprising one of or both parts 150-1 and/or 150-2, which may be implemented in a number of ways. The cell search module 150 may be implemented in hardware as cell search module 150-1, such as being implemented as part of the one or more processors 152. The cell search module 150-1 may be implemented also as an integrated circuit or through other hardware such as a programmable gate array. In another example, the cell search module 150 may be implemented as cell search module 150-2, which is implemented as computer program code 153 and is executed by the one or more processors 152. For instance, the one or more memories 155 and the computer program code 153 are configured to, with the one or more processors 152, cause the gNB 170 to perform one or more of the operations as described herein. The one or more network interfaces 161 communicate over a network such as via the links 176 and 131. Two or more gNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the gNB 170 being physically in a different location from the RRH, and the one or more buses 157 could be implemented in part as fiber optic cable to connect the other elements of the gNB 170 to the RRH 195.

It is noted that description herein indicates that “cells” perform functions, but it should be clear that the eNB that forms the cell will perform the functions. The cell makes up part of an eNB. That is, there can be multiple cells per gNB. For instance, there could be three cells for a single eNB carrier frequency and associated bandwidth, each cell covering one-third of a 360 degree area so that the single gNB's coverage area covers an approximate oval or circle. Furthermore, each cell can correspond to a single carrier and a gNB may use multiple carriers. So if there are three 120 degree cells per carrier and two carriers, then the eNB has a total of 6 cells.

The wireless network 100 may include a network control element (NCE) 190 that may include MME (Mobility Management Entity)/SGW (Serving Gateway) functionality, and which provides connectivity with a further network, such as a telephone network and/or a data communications network (e.g., the Internet). The gNB 170 is coupled via a link 131 to the NCE 190. The link 131 may be implemented as, e.g., an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, gNB 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the exemplary embodiments of this invention, the exemplary embodiments will now be described with greater specificity.

The exemplary embodiments herein are related to 3GPP New Radio (NR) physical layer design. Especially we focus on UE's idle mode operation and enhancing the initial cell search in NR.

As background, there may be deployments where, in a radio frequency band, there is only a secondary carrier for a certain operator in the band, i.e., which does not provide functionality for initial access but transmits SSBs for synchronization and (secondary) cell detection. Thus, in that carrier, there may be SSB or even multiple SSB frequency locations but without associated RMSI. In all of those SSBs, the PBCH would indicate to the UE that there is no associated RMSI and also the PBCH cannot direct the UE to any SSB frequency location within a carrier where there would be associated SSB. Thus, when the UE 110 starts an initial cell search on such a carrier, the UE 110 will go through all the synch raster positions, finding no associated RMSI for each detected SSB and after going through the carrier, the UE 110 would change the frequency (e.g., to another carrier). This is a time- and energy-consuming operation for the UE.

To highlight the current status in 3GPP, the following agreement was made in RAN1#91 (reference may be made to “Draft Report of 3GPP TSG RAN WG1 #91 v0.2.0”, now entitled R1-1801301, Report of RAN1#91 meeting, ETSI, and approved in RAN1 #92):

For an SSB on the sync raster, the indication of no associated RMSI is done using reserved value(s) in SSB-subcarrier-offset; If no RMSI present, RMSI-PDCCH-Config is used to signal the next sync raster that UE should search for cell-defining SSB.

According to page 64 of the “Draft Report of 3GPP TSG RAN WG1 #91 v0.2.0”, from R1-1721684, entitled “WF on RMSI presence flag”, by Qualcomm: RMSI presence is indicated by reserved value(s) in SSB-subcarrier-offset. If no RMSI is present, RMSI-PDCCH-Config is used to signal the next sync raster that UE should search for cell-defining SSB. This is now on page 65 of R1-1801301, Report of RAN1#91 meeting, ETSI, and approved in RAN1 #92.

It is noted that one possible definition of “cell-defining SSB” is that this SSB contains (e.g., indicates) carrier information for the RMSI.

That means that parameter field which is used to indicate to the UE the subcarrier level shift {0, . . . , 11} the SSB is located in relation to PRB grid can be used to indicate whether there is associated RMSI. Note that this range is {0, . . . , 11} for above 6 Ghz but {0, . . . , 23} for sub 6 GHz bands for the case that RMSI numerology is 30 kHz. If no RMSI is present, then CORESET configuration bits (i.e., 8 bits) are used to signal the UE as to where the UE should search for the next cell-defining SSB. This indication could be done indicating the location of the cell-defining SSB in a relative manner, as a relative offset to the given SSB as a function of SS raster steps. Alternatively, the indication could be done as direct indication using the bits and predefined bands specific offset together to determine the exact location of the cell-defining SSB. At least the following problems are identified.

First, an idle mode UE performing an initial search and access is looking for SSB with RMSI associated to the SSB. Now, the UE would just move the next raster point indicated and also there (at the next raster point) the situation may be that no RMSI is present.

Second, range in frequency is limited with 8 bits to indicate the next frequency location because it is assumed that subcarrier level granularity is used for the indication.

Regarding the second problem, 8 bits can provide 256 different states, i.e., using 8 bits we can point to 256 SSB entry positions. If there are more than 256 entry positions within a band, 8 bits would not be enough. Then we have two options:

1) SSB-subcarrier-offset parameter in PBCH could indicate that there is no RMSI and that RMSI-PDCCH-Config would point to one entry among first 256 entries within a band where to find cell defining SSB (and RMSI), or SSB-subcarrier-offset parameter could indicate that there is no RMSI and that RMSI-PDCCH-Config would point to one entry among next 256 (entries 257-512) entries where to find SSB+RMSI, and so on.

2) SSB-subcarrier-offset parameter would indicate that there is no RMSI and that RMSI-PDCCH-Config would indicate frequency range on which there is no SSB with RMSI.

Also, this considered problem might be stated as follows. It could be possible that for certain carriers/bands for a given operator, there would not necessarily be any SS/PBCH blocks that carry valid RMSI information, and only for example off-raster SS/PBCH blocks would be present. Hence, there would be a need to reserve a certain index to inform this to the UE. Naturally, the UE is at this stage not necessarily aware to which PLMN the detected SS/PBCH block belongs, and hence cannot conclude that there are not any SS/PBCH blocks with valid RMSI in the given band, e.g., by other operators. Therefore, in these cases, the UE should not necessarily stop searching for additional SS/BPCH blocks. Of course it could be considered that the CORESET information would be re-used to indicate a range within which UE should not expect to find SS/PBCH block with valid RMSI information, enabling the UE to skip these in the initial cell selection. In other words, it may be beneficial for the UE performing initial search to know from which frequency range at least the UE cannot find SSB with RMSI needed for initial access.

It is proposed herein, to address these problems, that the SSB would signal to UEs that whether or not associated RMSI can be found within an indicated frequency range (or not).

Using the RMSI CORESET configuration, if SSB with valid RMSI can be found within a frequency range (e.g., within a frequency range X) from the detected SSB, the SSB would signal the frequency location. By contrast, concerning the case (covered herein) where the RMSI cannot be found within a frequency range (e.g., frequency range X) from the detected SSB or it is not known (e.g., by the given operator) if the RMSI is present, the SSB would signal that no RMSI can be found until after frequency range X. That could be further enhanced by indicating to which direction in frequency or by indicating a minimum range in both directions. Concerning the minimum range in both directions, this could be that the frequency range X means going X to higher in frequency and X to lower in frequency. It is also possible the UE, starting from somewhere such as a current frequency for an SSB, would proceed from the lowest frequency and search in one direction only. This is, however, up to UE implementation, and thus there could be a case where an SSB could indicate a frequency range into both directions within which there is no SSB with RMSI of the operator.

Turning to FIG. 2, this figure is an illustration of a frequency band (FB) with SSBs 210, 220, and operations performed in accordance with an exemplary embodiment herein. Shown is a first carrier 230-1 of a home operator, having a frequency band FB1. A second carrier 230-2 is shown, which is a carrier 230 of a neighbor operator, having a frequency band FB2. There are five SSBs without associated RMSI: 210-1, 210-2, 210-3, 210-4, and 210-5. The first three SSBs (210-1 to 210-3) are in the frequency band FB1 and the last two SSBs (210-4 and 210-5) are in the frequency band FB2. There is one SSB 220-1 with associated RMSI, and this is within frequency band FB2 of the second carrier 230-2.

One example of a possible embodiment comprises the following:

1. The UE detects SSB 210-2, which indicates that there is no SSB 220 with associated RMSI within X MHz (where MHz is an example).

2. The UE continues searching SSBs 210/220 after the indicated X MHz, from the frequency f (e.g., the “current” frequency), where the X MHz was detected corresponding to the SSB 210-2 providing the indication.

During the cell search that takes place after the frequency range X, relative to the current frequency f, the UE 110 should find the SSB 220-1 with associated RMSI and, e.g., determine information for the neighbor cell.

In the example of FIG. 2, it is assumed that the home operator may likely configure the frequency range X so that the frequency range X covers the (e.g., remaining) range of the carrier (e.g., having frequency range of FB1) the operator has within a band. Basically, the UE can skip then frequencies within the frequency range X from the detected SSB. The home operator is likely not aware of SSBs within a carrier of the other (neighbor) operator, although this is not precluded.

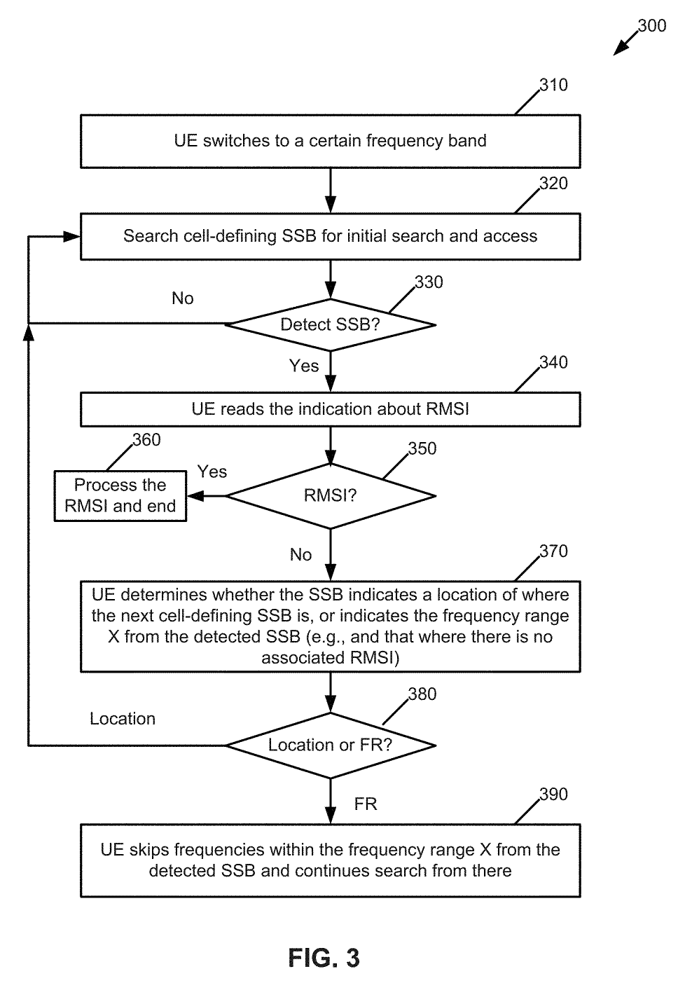

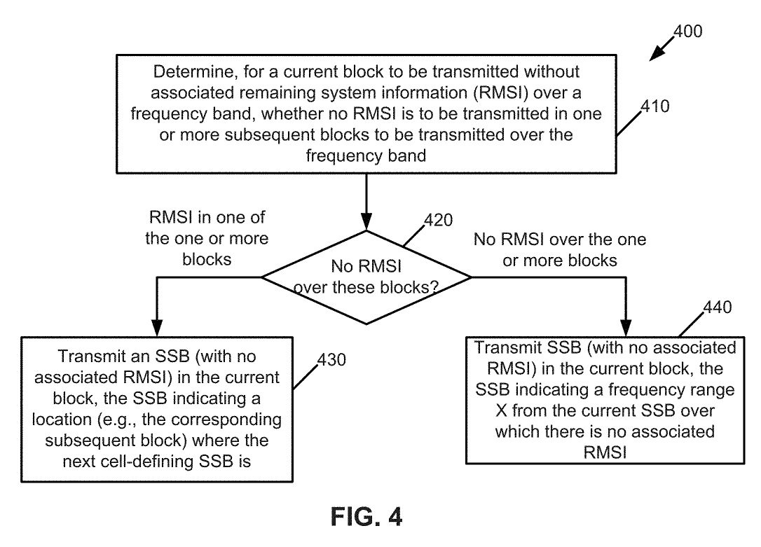

Additional examples are presented below with respect to FIGS. 3 and 4.

FIG. 3 is a logic flow diagram for enhanced cell search performed by a UE. This figure further illustrates the operation of an exemplary method or methods, a result of execution of computer program instructions embodied on a computer readable memory, functions performed by logic implemented in hardware, and/or interconnected means for performing functions in accordance with exemplary embodiments. For instance, the cell search module 140 may include multiples ones of the blocks in FIG. 3, where each included block is an interconnected means for performing the function in the block. The blocks in FIG. 3 are assumed to be performed by the UE 110, e.g., under control of the cell search module 140 at least in part.

One example of possible UE-side operation, as part of a process 300 for performing a search for cells in a wireless communication system, is as follows. In block 310, the UE switches to a certain frequency band. The UE starts in block 320 searching cell-defining SSB 210/220 for initial search and access.

In block 330, it is determined if an SSB 210/220 is detected in the PBCH. If not (block 330=No), the flow proceeds back to block 320. If so (block 330=Yes), the UE upon detection of an SSB the UE reads the indication about RMSI. See block 340. The UE in block 350 determines if there is an RMSI in the SSB. If so (block 350=Yes), the UE processes the RMSI in block 360 and the flow ends. It is assumed with the processing that UE gets parameters, e.g., for a random access procedure and may continue initial access from there. Also, the UE 110 will likely get a global cell ID (identification) from RMSI needed for measurements, so the flow ends in response to the UE finding the RMSI.

If UE determines from SSB (PBCH) that there is no RMSI (block 350=No), the UE determines in block 370 whether SSB (PBCH) 210/220 then indicates a location of where the next cell-defining SSB is, or indicates the frequency range X from the detected SSB (e.g., and that where there is no associated RMSI). In block 380, if the location is indicated (block 380=Location), the flow proceeds to block 320 where the UE 110 continues to search for cell-defining SSBs (e.g., starting at the indicated location). In block 380, if the frequency range (e.g., X in FIG. 2) is indicated (block 380=FR), the UE skips frequencies within the frequency range X from the detected SSB (e.g., at the current frequency f in FIG. 2) and continues the search from there. See block 390. Note that conclusion of block 390 may go back to block 310, e.g., so that the UE 110 can select another frequency band, such as frequency band FB2 of the carrier 230-2 of the neighbor operator (see FIG. 2). In more detail for the routing, if the UE comes to an end of valid SS raster locations in the band, then the UE would change the frequency band (e.g., go from block 390 to 310), but otherwise the UE would not change the band. That is, one operator could have 10 MHz of the 200 MHz band, while other operator(s) having portions of the same band could have SSBs with RMSI. And at this stage UE does not know (or cannot be assume to know) which operator it is hearing as, e.g., PLMN information comes later.

It is noted that a result of the process 300 should be that the UE has found at least one cell into which the UE can camp into and perform initial access. Initial access in this context means a random access procedure, synchronization with gNB, and getting an active connection.

FIG. 4 is a logic flow diagram for enhanced cell search performed by a network element (e.g., a gNB 170). This figure further illustrates the operation of an exemplary method or methods, a result of execution of computer program instructions embodied on a computer readable memory, functions performed by logic implemented in hardware, and/or interconnected means for performing functions in accordance with exemplary embodiments. For instance, the cell search module 150 may include multiples ones of the blocks in FIG. 4, where each included block is an interconnected means for performing the function in the block. The blocks in FIG. 4 are assumed to be performed by a base station such as gNB 170, e.g., under control of the cell search module 150 at least in part. The network element may also be relay node, RRH, or even some other device such as if fixed relays or some devices act as synchronization nodes.

The following is an example of gNB/network side operation. Succinctly, for the SSBs with no associated RMSI, the network element (e.g., gNB/other network node) transmits SSB indicating where the next cell-defining SSB is, or indicating the frequency range X from the detected SSB over which there is no associated RMSI. The indication of frequency range X lets the UE 110 know, as previously described, to skip searching over the frequency range X (from the current frequency range f of the current SSB, as illustrated in FIG. 2).

The process 400 is a process for enhanced cell search. In block 410, the gNB 170 determines, for a current block to be transmitted without associated remaining system information (RMSI) and over a frequency band, whether no RMSI is to be transmitted in one or more subsequent blocks to be transmitted over the frequency band. The one or more subsequent blocks are blocks that are subsequent to the current block. The current and subsequent blocks may belong to a burst set of blocks, for instance. In FIG. 2, the current block might be the SSB 210-2, and the subsequent blocks would then be block 210-3.

If there is RMSI over one of these blocks (block 420=RMSI in one or more of the blocks), in block 430, the gNB 170 transmits an SSB (with no associated RMSI) in the current block, where the SSB indicates a location (e.g., of the corresponding subsequent block) where the next cell-defining SSB is. If there is no RMSI over one of these blocks (block 420=No RMSI over the one or more blocks), in block 440 the gNB 170 transmits the SSB (with no associated RMSI) in the current block, where the SSB indicates a frequency range X from the current SSB over which there is no associated RMSI.

The following are additional exemplary embodiments.

### Example 1

A method, comprising:

performing a search for cells in a wireless communication system, comprising:

searching, by a user equipment and in a frequency band, for a block that comprises a synchronization signal;

determining, by the user equipment and in response to finding the synchronization signal within the block, whether there is an indication in the block of a frequency range in which no remaining system information will be found;

skipping, by the user equipment and in response to the indication being in the block, the search in frequencies from a current frequency corresponding to the block to a particular frequency after the indicated frequency range; and

continuing to search for cells in frequencies after the particular frequency.

### Example 2

The method of example 1, wherein the block is part of a burst set of blocks.

### Example 3

The method of any of examples 1 or 2, wherein the block that comprises a synchronization signal is in a frequency range of a first carrier and the indicated frequency range is defined so that the indicated frequency range encompasses a remaining frequency range of the first carrier from the current frequency to an ending frequency of the first carrier, and the continuing to search skips the remaining frequency range of the first carrier.

### Example 4

The method of any of examples 1 to 3, wherein the indication further indicates to which direction in frequency should be skipped and the skipping is performed in the direction.

### Example 5

The method of any of examples 1 to 3, wherein the indication further indicates a minimum frequency range in both directions from the current frequency and the skipping is performed in both directions over the minimum frequency range from the current frequency.

### Example 6

The method of any of examples 1 to 5, wherein a result of the performed cell search is the user equipment has found at least one cell into which the user equipment can camp into and perform initial access.

### Example 7

A method, comprising:

determining, by a network element able to communicate with user equipment in a wireless communication system, that no remaining system information is to be transmitted in a block and in one or more subsequent blocks to be transmitted over a frequency band;

transmitting the block, wherein the block comprises a synchronization signal and is used for user equipment to search for cells, and including in the block an indication of a frequency range, from a current frequency corresponding to the transmitted block and in the frequency band, over which no remaining system information will be found.

### Example 8

The method of example 7, wherein the block is part of a burst set of blocks also including the one or more subsequent blocks.

### Example 9

The method of any of examples 7 or 8, wherein the block that comprises a synchronization signal is in a frequency range of a first carrier formed by the network element and the indicated frequency range is defined so that the indicated frequency range encompasses a remaining frequency range of the first carrier from the current frequency to an ending frequency of the first carrier.

### Example 10

The method of any of examples 7 to 9, wherein the indication indicates to the user equipment that frequencies from a current frequency for the block until after the indicated frequency range should be skipped, and wherein the indication further indicates to which direction in frequency should be skipped.

### Example 11

The method of any of examples 7 to 9, wherein the indication indicates to the user equipment that frequencies from a current frequency for the block until after the indicated frequency range should be skipped, and wherein the indication further indicates a minimum frequency range in both directions from the current frequency and the skipping is performed in both directions over the minimum frequency range from the current frequency.

### Example 12

An apparatus, comprising:

at least one processor; and

at least one memory including computer program code,

the at least one memory and the computer program code configured to, with the at least one processor, cause the apparatus to perform any of the above methods.

### Example 13

An apparatus comprising means for performing any of the above methods.

### Example 14

A computer program product comprising a computer-readable medium bearing computer program code embodied therein for use with a computer, the computer program code comprising code for performing any of the above methods.

### Example 15

A computer program, comprising code for performing any of the above methods, when the computer program is run on a processor.

### Example 16

The computer program according to example 15, wherein the computer program is a computer program product comprising a computer-readable medium bearing computer program code embodied therein for use with a computer.

Concerning indication of valid RMSI location, in email discussion following the RAN1#91, following agreement was reached:

Agreements:
For an SSB on the sync raster, the indication of no associated RMSI is done using reserved value(s) in SSB-subcarrier-offset. If no RMSI present, RMSI-PDCCH-Config is used to signal the next sync raster that UE should search for cell-defining SSB.

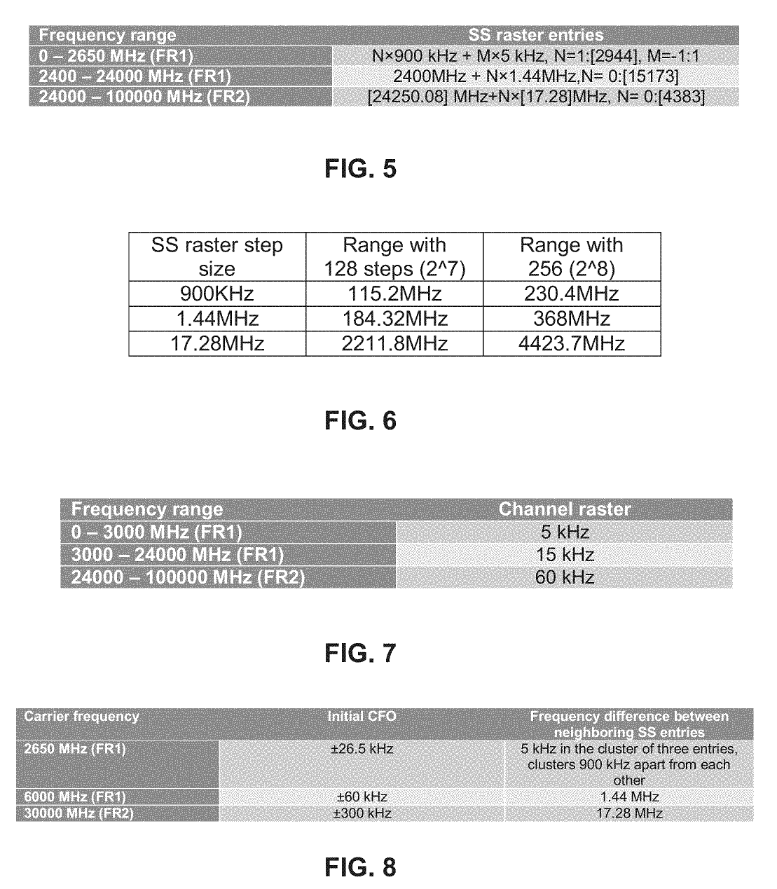

Based on RAN4 agreements, the SS raster entries would be as shown in FIG. 5.

The number of indexes should in principle be able to cover the full range steps to cover the largest band (˜times two) in terms of SS-raster points. Of course, the interpretation of the indexes needs to be in some extent frequency range specific so that the right frequency locations are detected, so the range of indexes used could also be different e.g. for different frequency bands. When considering the NR bands after RAN Plenary #78, it can be seen that for certain bands a quite large number of indexes are needed to be covered. For instance, for bands like n50/51, n66 and n75, 300 indices would be needed. This large number of indices is a result of the clustered approach for SS raster below 2.65 GHz. For most cases, the total maximum number of needed raster points is less than 200.

As pointing to each individual cluster point below 2650 MHz triples the number of indices required, it could be considered to reduce the number of needed indices so that the cluster only is addressed, and then a UE would need to consider all three different locations as possible candidate locations when doing the initial cell selection. This would seem to be an acceptable compromise in terms of reference points and UE initial cell selection complexity reduction.

Observation: The number of needed raster points is driven by ≤2650 MHz SS-raster with 900 MHz cluster steps and [−5:0:+5] kHz raster points. If only the cluster would be addressed, the number of could be reduced by only indicating the SS-raster cluster point.

Proposal: When informing the location of SS/PBCH with RMSI for bands that use SS-raster with 900 MHz cluster steps and [−5:0:+5] kHz raster points, only the location of the cluster would be indicated and UE would consider all three raster points (of the cluster) as candidates in initial cell selection.

Using the 8-bits in RMSI-PDCCH-Config (note that RMSI-PDCCH-Config is the same as pdccch-ConfigSIB1, as the name was changed during the specification work) to indicate the SS raster entries, could be done in various manners, depending on the details, and number of bits used and joint coding applied for the SSB-subcarrier-offset and RMSI presence indicator, but on a high level either direct indication or relative indication could be used. In case of direct indication (or with predefined offset) the exact SS raster location would be determined within the given frequency band. That is, the 8-bits of RMSI-PDCCH-Config would be interpreted as ARFCN (Absolute Radio Frequency Channel Number) for the SS raster. This approach would be most straight forward, assuming that the range is sufficient. The other option, relative indication, where the bits would be interpreted as offset in terms of SS raster steps, could require fewer bits as it might not be necessary to be able to point full range of SS raster locations. However, one bit would be required to indicate the sign (±), i.e. direction of the relative step. The table illustrated in FIG. 6 summarizes the ranges that can be achieved. When considering the current bands being considered by RAN4, it can be seen that most reframing bands could be covered with direct indication if full 8 bits is used. For new bands considered for Rel-15 below 6 GHz, where bandwidths up to 900 MHz are considered, the direct indication might not be possible for all bands unless the used range can be extended. Same applies of course for the relative indication (accounting also the need for sign bit), but if is seen that more limited range is sufficient for practical deployments (e.g., due to assumed minimum ‘density’ of SS/PBCH blocks), relative indication could be used. For mmWave bands that RAN4 is currently considering for Rel-15, the total maximum bandwidth is 3.25 GHz. It would seem that as all these bands would be using 17.28 MHz SS raster, both direct indication, and relative indication (fully if some additional code point is used for sign indication) could be considered for these cases.

Observation: For currently considered reframing bands, using direct indication of the SS/PBCH block with RMSI would seem possible.

Like noted above, ranges provided in the table of FIG. 6 could of be extended, by using additional bits (for <6 GHz bands) and/or by additional codepoints SSB-subcarrier-offset indication. It is good however to keep in mind that additional entries could be needed to indicate the SS raster cluster location for the bands that use the 3-cluster SS raster. In addition like noted further below, there is need also to reserve indication for the case that no SS/PBCH with RMSI is present (by given operator). Hence there can be a limited number of bits to which the extension can be done. However, use of direct indication seems preferable as it would save in total number of indications required. I.e., if full range need to be covered for both directions, additional indication would be needed for each range extension or one bit to indicate the sign of the offset.

Proposal: It would seem preferable to use the direct indication to indicate the frequency location of the SS/PBCH with RMSI.

Hence the exact mapping of the RMSI-PDCCH-Config to Global Synchronization Channel Number (GSCN) for each frequency band could be determined in RAN4 specification (e.g. 3GPP TS 38.101) simply by defining fixed offset (e.g. bit similarly as RF channel numbers are defined).

Observation: Exact mapping of the RMSI-PDCCH-Config to Global Synchronization Channel Number (GSCN) for each frequency band could be determined in RAN4 specification.

As also raised, there could be cases when the actual location of the SS/PBCH with valid RSMI cannot be informed. That is, in certain cases, a given operator might consider the carrier as NSA carrier and use off-raster SS/PBCH blocks. Hence, the interpretation of the offset indication could be different in this case. The indication could be used for example to inform the UE the range within which it would not need to expect to find SS/PBCH block with valid RMSI. This would be for example done so that the 8-bits of RMSI-PDCCH-Config is divided in to 4 bit blocks which each indicate the range in relative manner towards lower and higher frequency range. The range indication could be for example tight to the SS raster step size.

Observation: There is a need also to indicate to the UE if there is no SS/PBCH with valid RMSI information (e.g., for a given operator). In this case, it would be preferable that UE would not stop the initial cell selection procedure on the given carrier.

Observation: In the case that the location of the next SS/PBCH block with RMSI is not known, the 8 bits of RMSI-PDCCH-Config could be used to indicate to the UE the range where it is known that no SS/PBCH with RMSI is present.

Concerning SS/PBCH block raster locations and RMSI presence, based on RAN1#91 agreements SS/PBCH blocks can be located either on or off the synch raster.

Agreements:
For measurement, SSB frequency location (except for cell defining SS/PBCH blocks of the serving cell which supports standalone access) may or may not be located on the sync raster.

The blocks on the synch raster can be ‘cell defining’ SS/PBCH blocks that have associated RMSI, whereas additional SS/PBCH blocks can be located off the synch raster and are used e.g. for measurements. These off-raster SS/PBCH blocks would not have valid RMSI information. Possibly also a third class of SS/PBCH blocks can be considered, such that they reside on the SS-raster, but do not encompass valid RMSI.

In relation to these SS/PBCH blocks, it was agreed in RAN1#91 email discussion “[91-NR-04] RMSI presence indication” that for an SS/PBCH block on the sync raster, the indication of no associated RMSI can be done using reserved value(s) in SSB-subcarrier-offset. And, if there is no associated RMSI present, RMSI-PDCCH-Config of NR-PBCH payload can be used to signal the next sync raster that UE should search for cell-defining SSB.

Agreements:
For an SSB on the sync raster, the indication of no associated RMSI is done using reserved value(s) in SSB-subcarrier-offset. If no RMSI present, RMSI-PDCCH-Config is used to signal the next sync raster that UE should search for cell-defining SSB.

In subsequent description below, we discuss about how the aforementioned indication can be done accounting also the latest RAN4 agreements in relation to channel and SS raster.

Based on RAN4 agreements, the channel raster for NR per frequency range would be as illustrated in the table shown in FIG. 7, and the SS raster entries would be as shown in FIG. 5. Considering UE's initial cell search and assuming ±10 ppm initial carrier frequency error due to oscillator mismatch, the initial CFOs and frequency difference between neighboring SS raster entries are as shown in FIG. 8.

Based on the above calculations, the UE may have ambiguity in determining the correct carrier frequency because the frequency difference between SS raster entries within a cluster of three is less than the initial CFO (i.e., the frequency error of the UE) at the UE at below 2650 MHz carrier frequency range. In other words, when the UE detects NR-PSS, there may be uncertainty at the UE whether the NR-PSS is located in the left-most, center or the right-most SS entry of the cluster three entries (i.e., M={−1,0,+1}).

Observation: At below 2650 MHz carrier frequency range, the UE may have uncertainty about the correct carrier frequency the NR-PSS is located because of SS raster entries being allocated in clusters where frequency difference of the entries within the cluster may be lower than UE's initial CFO.

Observation: At below 2650 MHz, the UE may need to be indicated which one of the three entries of the SS entry cluster the NR-PSS is transmitted using two available reserved bits in NR-PBCH (two of three bits used for 3 MSBs of an SS block location index at above 6 GHz).

As discussed above, direct indication about the next sync raster could be preferably implemented as ARFCN for the SS raster, i.e., indicating the location of the SS/PBCH with RMSI directly. For instance, let's consider an NR band n79 (being considered for Rel-15 by RAN4) that has 600 MHz bandwidth at 4.5 GHz. 256 states in RMSI-PDCCH-Config can point SS raster entries within a ˜370 MHz bandwidth (assuming 1.44 MHz raster). To be able to point to each SS entry within 600 MHz bandwidth, the indication range should be extended. For this band, the SSB-subcarrier-offset parameter could have two states reserved for indicating that no RMSI and that RMSI-PDCCH-Config points to the next cell defining SSB. First state could indicate the first 256 entry points within a band and the second state the next 256 entry points within a band. Similar observation can be made for n77, where 900 MHz total bandwidth is supported, one additional range would be needed to cover the full extent of the band.

Proposal: SSB-subcarrier-offset has three states for indicating whether RMSI-PDCCH-Config indicates first 256 SS entries within a band, next SS entries 257-512 or 513-768 within a band at below 6 GHz.

In addition, it could be possible that for certain carriers/bands for a given operator, there would not necessarily be any SS/PBCH blocks that carry valid RMSI information, and only for example off-raster SS/PBCH blocks would be present. Hence there would be a need to reserve certain index to inform this to UE. Naturally, a UE is not at this stage necessarily aware as to which PLMN the detected SS/PBCH block belongs to and hence cannot conclude that there are not any SS/PBCH blocks with valid RMSI in the given band, e.g., by other operators. Therefore, in these cases, the UE should not necessarily stop searching for additional SS/BPCH blocks. Of course it could be considered that the CORESET information would be re-used to indicate a range within which the UE should not expect to find SS/PBCH block with valid RMSI information, enabling UE to skip these in the initial cell selection. In other words, it may be beneficial for the UE performing initial search to know from which frequency range at least the UE cannot find SSB with RMSI needed for initial access.

Observation: There is a need also to indicate to the UE if there is no SS/PBCH with valid RMSI information (e.g. for a given operator). In this case, it would be preferable that UE would not stop the initial cell selection procedure on the given carrier.

Observation: It is seen beneficial for the UE performing initial search to know from which frequency range it cannot find SSB with RMSI needed for initial access.

Thus, there are at least two types of no-RMSI-indication signaling needed. Type 1: no RMSI indication+information where the next cell defining SS/PBCH block is located. Type 2: no RMSI indication+information about the frequency range where the UE cannot find SS/PBCH block with RMSI.

Observation: There are at least two types of no RMSI indication signaling needed:

Type 1: no RMSI indication+information where the next cell defining SS/PBCH block is located

Type 2: no RMSI indication+information about the frequency range where the UE cannot find SS/PBCH block with RMSI

Proposal: PBCH supports indication that there are no RMSI (using SSB-subcarrier-offset field) and the frequency range where there is no SSB with RMSI (that RMSI-PDCCH-Config in PBCH indicates).

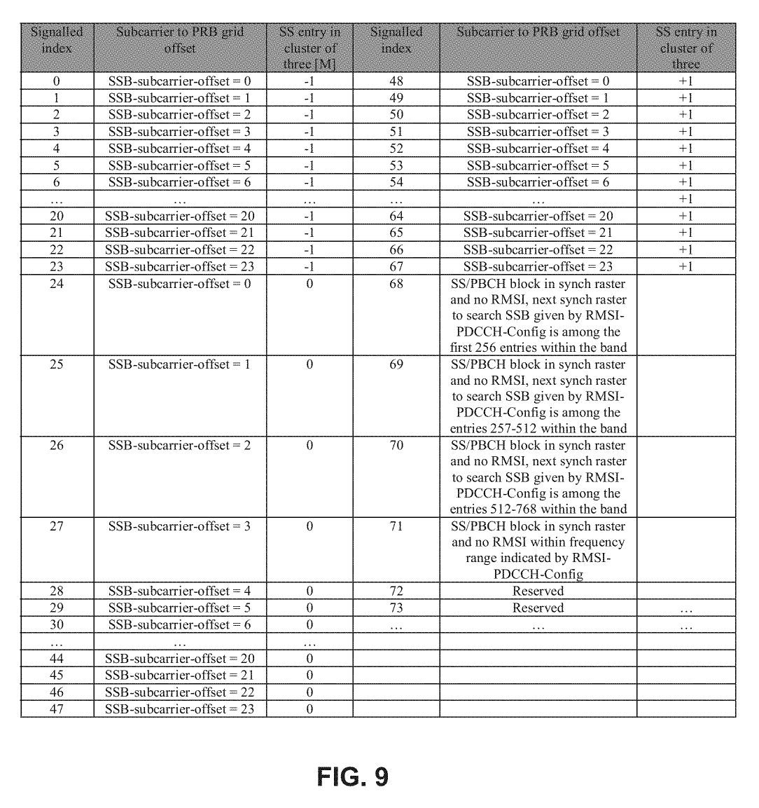

As a result, given the potential need to signal which one of the SS raster entries of the cluster of three, to signal whether SS/PBCH block is in raster or not, to signal whether or not RMSI is present, and in case RMSI is not present to signal within which frequency range RMSI is not present a 7-bit signaling is needed in NR-PBCH as presented in the table illustrated in FIG. 9.

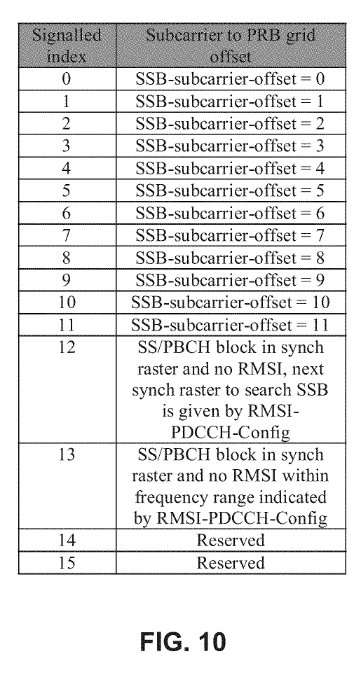

Then for above 6 GHz carrier frequency ranges, there is no need for indicating a used SS raster entry within a cluster of entries and thus 4-bit indication signaling would be enough to signal SSB-subcarrier-offset, to signal whether SS/PBCH block is in raster or not and to signal whether or not RMSI is present and in case RMSI is not present to signal within which frequency range RMSI is not present as illustrated in the table in FIG. 10.

As a summary, we make the following observations regarding the joint coding:

Observation: 7 bits are needed to signal a UE with SS-subcarrier-offset, SS raster entry within a cluster of entries, on- or off-SS raster SS/PBCH block and RMSI presence indication at below 6 GHz.

Observation: 4 bits are needed to signal a UE with SS-subcarrier-offset, on- or off-SS raster SS/PBCH block and RMSI presence indication at above 6 GHz.

Without in any way limiting the scope, interpretation, or application of the claims appearing below, a technical effect and also an advantage of one or more of the example embodiments disclosed herein is that a UE's initial cell search is enhanced, as the UE can skip frequency ranges not providing RMSI.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

3GPP third generation partnership project

5G fifth generation

ARFCN Absolute Radio Frequency Channel Number

CFO carrier frequency offset

CORESET control resource set

DMRS demodulation reference signal

eNB (or eNodeB) evolved Node B (e.g., an LTE base station)

FB frequency band

FR frequency range

GHz giga-Hertz

gNB (or gNodeB) Node B for new radio/5G (e.g., a NR/5G base station)

GSCN Global Synchronization Channel Number

HF half frame

ID identification

I/F interface

kHz kilo-Hertz

LTE long term evolution

MHz mega-Hertz

MME mobility management entity

ms milliseconds

NCE network control element

NR new radio

N/W network

PBCH physical broadcast channel

PDCCH physical downlink control channel

PDSCH physical downlink shared channel

PRB physical resource block

PSS primary synchronization signal

RMSI remaining system information

RRH remote radio head

Rx receiver

SGW serving gateway

SS synchronization signal

SSS secondary synchronization signal

SSB SS/PBCH block

Tx transmitter

UE user equipment (e.g., a wireless, typically mobile device)

1. A method, comprising:
performing a search for cells in a wireless communication system, comprising:
searching, by a user equipment and in a frequency band, for a block that comprises a synchronization signal;
determining, by the user equipment and in response to finding the synchronization signal within the block, whether there is an indication in the block of a frequency range in which no remaining system information will be found; and
continuing, by the user equipment and in response to the indication being in the block, to search for cells in frequencies after the particular frequency.

2. The method of claim 1, wherein the method further comprises skipping, by the user equipment and in response to the indication being in the block, the search in frequencies from a current frequency corresponding to the block to a particular frequency after the indicated frequency range.

3. The method of claim 1, wherein the block is part of a burst set of blocks.

4. The method of claim 1, wherein the block comprises a synchronization signal/physical broadcast channel block.

5. The method of claim 1, wherein the block that comprises a synchronization signal is in a frequency range of a first carrier.

6. The method of claim 1, wherein the indication further indicates to which direction or directions in frequency should be continued to be searched.

7. The method of claim 1, wherein the indication further indicates a number of synchronization signal raster steps used to determine where the continuing to search for cells in frequencies after the particular frequency is performed.

8. The method of claim 1, wherein the indication further indicates a minimum frequency range in both directions from a current frequency.

9. The method of claim 1, wherein the indication further indicates a first frequency range in first direction from a current frequency and a second frequency range in a second direction from the current frequency.

10. The method of claim 1, wherein the indication comprises a part divided into four-bit blocks, a first four-bit block indicating a frequency range in a relative manner towards a lower frequency range from a current frequency, and a second four-bit block indicating a frequency range in a relative manner towards a higher frequency range from the current frequency.

11. The method of claim 1, wherein a result of the performed cell search is the user equipment has found at least one cell into which the user equipment can camp into and perform initial access.

12. A method, comprising:
determining, by a network element able to communicate with user equipment in a wireless communication system, that no remaining system information is to be transmitted in a block and in one or more subsequent blocks to be transmitted over a frequency band; and
transmitting the block, wherein the block comprises a synchronization signal and is used for user equipment to search for cells, and including in the block an indication of a frequency range, from a current frequency corresponding to the transmitted block and in the frequency band, over which no remaining system information will be found.

13. The method of claim 12, wherein the block is part of a burst set of blocks also including the one or more subsequent blocks.

14. The method of claim 12, wherein the block comprises a synchronization signal/physical broadcast channel block.

15. The method of claim 12, wherein the block that comprises a synchronization signal is in a frequency range of a first carrier formed by the network element and the indicated frequency range is defined so that the indicated frequency range encompasses a remaining frequency range of the first carrier from the current frequency to an ending frequency of the first carrier.

16. The method of claim 12, wherein the indication indicates to the user equipment that no remaining system information will be found in frequencies from a current frequency for the block until after the indicated frequency range, and wherein the indication further indicates to which direction in frequency no remaining system information will be found.

17. The method of claim 12, wherein the indication indicates to the user equipment that no remaining system information will be found in frequencies from a current frequency for the block until after the indicated frequency range, wherein the indication further indicates a number of synchronization signal raster steps in which no remaining system information will be found.

18. The method of claim 12, wherein the indication indicates to the user equipment that no remaining system information will be found in frequencies from a current frequency for the block until after the indicated frequency range, and wherein the indication further indicates a minimum frequency range in both directions from the current frequency in which no remaining system information will be found.

19. The method of claim 12, wherein the indication indicates to the user equipment that no remaining system information will be found in frequencies from a current frequency for the block until after the indicated frequency range, and wherein the indication further indicates a first frequency range in first direction from a current frequency in which no remaining system information will be found and a second frequency range in a second direction from the current frequency in which no remaining system information will be found.

20.-41. (canceled)

42. An apparatus, comprising:
at least one processor; and
at least one memory including computer program code,
the at least one memory and the computer program code configured, with the at least one processor, to cause the apparatus to perform operations comprising:
performing a search for cells in a wireless communication system, comprising:
searching, by a user equipment and in a frequency band, for a block that comprises a synchronization signal;
determining, by the user equipment and in response to finding the synchronization signal within the block, whether there is an indication in the block of a frequency range in which no remaining system information will be found; and
continuing, by the user equipment and in response to the indication being in the block, to search for cells in frequencies after the particular frequency.

43. (canceled)
